(19) United States
(12) Patent Application Publication
(10) Pub. No.: US 2022/0212824 A1
(43) Pub. Date: Jul. 7, 2022

(54) MAGNETIC POUCH CLAMP ASSEMBLY AND RELATED METHODS

(71) Applicant: BARTELT PACKAGING LLC, Covington, KY (US)

(72) Inventor: Donald Scott Peebles, Bradenton, FL (US)

(21) Appl. No.: 17/143,744

(22) Filed: Jan. 7, 2021

(51) Int. Cl. B65B 43/46; B25J 15/00

(52) U.S. Cl. CPC B65B 43/465; B25J 15/0033

(57) ABSTRACT

A magnetic pouch clamp assembly includes a first and second clamping arms and a magnet assembly. The first clamping arms have respective, opposed first and second clamping surfaces. The second clamp arm is slidably connected to the first clamping arm such that the first and second clamping arms are movable between open and closed positions, with the first and second clamping surfaces being engaged in the closed position. The magnet assembly includes a first magnet having a first polarity carried by the first clamping arm and a second magnet having a second polarity carried by the second clamping arm, the first and second polarities being oriented such that a closing attractive force therebetween holds the first and second clamping surfaces in the closed position. A third magnet can be used to hold the clamping surfaces in the open position or to enhance closing forces.

### FIELD OF THE INVENTION

The present invention relates to pouching machines, and more particularly, to clamps for releasably holding the pouches through forming, filling and/or sealing operations.

### BACKGROUND OF THE INVENTION

Most pouching machines employ pairs of track-mounted clamps which successively receive pouches and carry them to various stations where different operations are performed on the pouches, typically including filling and sealing and, depending on the type of pouching machine, initial forming operations. The clamps then release the filled and sealed pouches, which may be grouped and loaded in cartons or subject to further processing.

Most commonly, each clamp is held closed by spring pressure and, when receiving or releasing pouches, the clamp is urged open by application of an external mechanical force. While such clamps have been effectively used for many years, further improvements are possible.

### SUMMARY OF THE INVENTION

In view of the foregoing, it is an object of the present invention to provide a magnetic pouch clamp assembly and related methods. According to an embodiment of the present invention, a magnetic pouch clamp assembly includes a first clamping arm, a second clamping arm and a magnet assembly. The first clamping arm has a first clamping surface, and the second clamping arm has a second clamping surface opposed to the first clamping surface. The second clamp arm is slidably connected to the first clamping arm such that the first and second clamping arms are movable between open and closed positions, with the first and second clamping surfaces being engaged in the closed position. The magnet assembly includes a first magnet having a first polarity carried by the first clamping arm and a second magnet having a second polarity carried by the second clamping arm, the first and second polarities being oriented such that a closing attractive force therebetween holds the first and second clamping surfaces in the closed position.

According to an aspect of the present invention, the magnet assembly includes a third magnet having a third polarity carried by the second clamping arm, the second and third magnets being located on opposite sides of the first magnet and the first and third polarities being oriented such that an opening attractive force therebetween holds the first and second clamping surfaces in the open position.

According to another aspect of the present invention, the first clamping arm defines a first guide slot and the second clamping arm defines a second guide slot, the first clamping arm includes a first magnet housing slidably received in the second guide slot and carrying the first magnet, and the second clamping arm includes a second magnet housing slidably received in the first guide slot and carrying the second magnet.

These and other objects, aspects and advantages of the present invention will be better appreciated in view of the drawings and following detailed description of preferred embodiments.

### BRIEF DESCRIPTION OF THE DRAWINGS

FIG. 1 is a perspective view of a magnetic pouch clamp assembly, according to an embodiment of the present invention;

FIG. 2 is another perspective view of the magnetic pouch clamp assembly of FIG. 1, with a guide slot cover removed to show internal details;

FIG. 3 is a partially exploded perspective view of the magnetic pouch clamp assembly of FIG. 1;

FIGS. 4A and 4B are sectional views taken along line 4-4 of FIG. 1 with clamping surfaces in the open and closed positions, respectively;

FIG. 5 is a perspective view of a pair of magnetic pouch clamp assemblies mounted to carriages, according to another embodiment of the present invention.

### DETAILED DESCRIPTION OF PREFERRED EMBODIMENTS

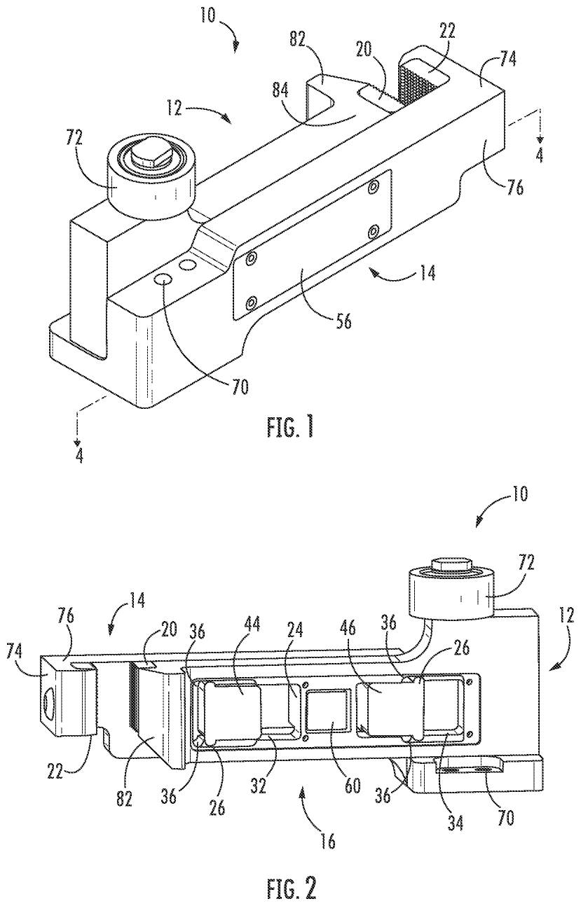

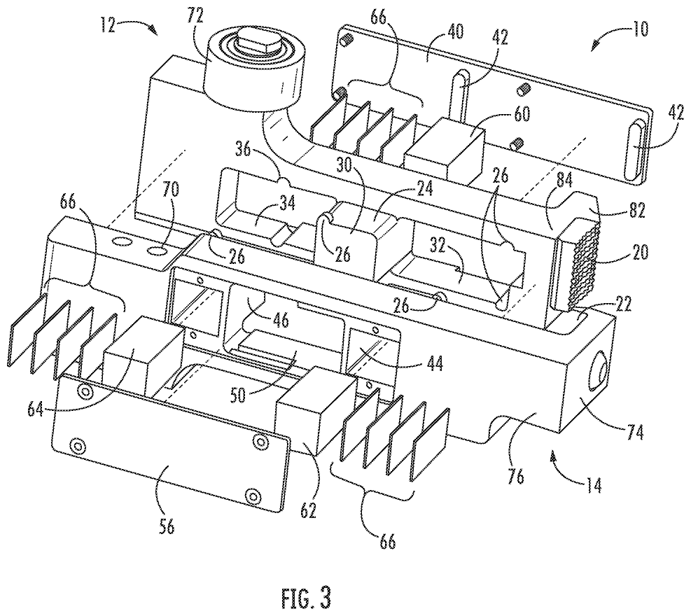

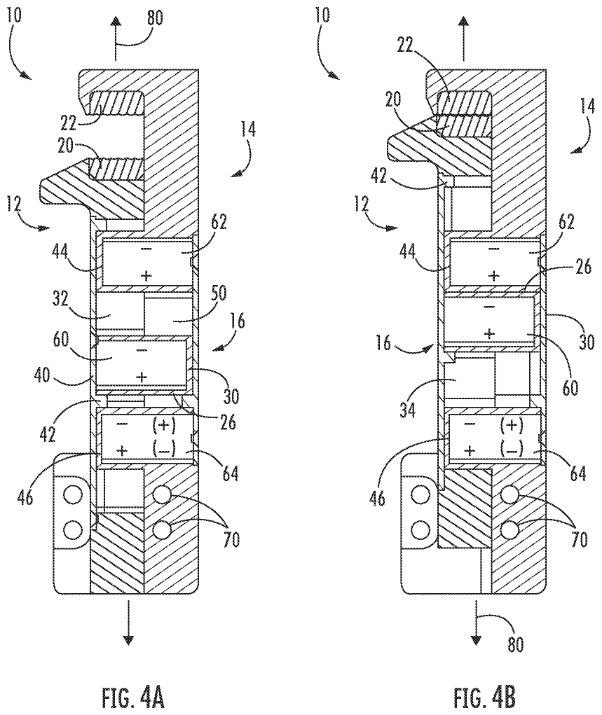

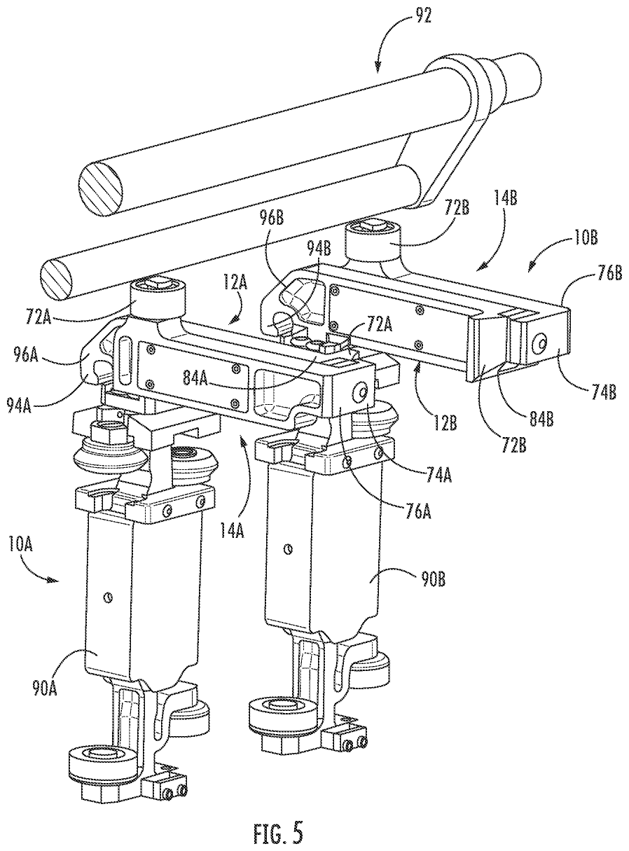

According to an embodiment of the present invention, referring to FIGS. 1-3, a magnetic pouch clamp assembly 10 includes slidably connected clamping arms 12, 14 carrying a magnet assembly 16. The magnet assembly 16 is operable to engage opposed clamping surfaces 20, 22 of the clamping arms 12, 14 in the open (FIG. 4A) and closed positions (FIG. 4B).

The clamping arm 12 includes a magnet housing 24 extending laterally therefrom through the clamping arm 14. Magnet housing retention lugs 26 extend upwardly and downwardly from a distal end 30 of the housing 24. Guide slots 32, 34 are defined in the clamping arm 12 extending across a width thereof.

Guide slot retention lug passages 36 are defined extending upwardly and downwardly from the guide slots 32, 34. A guide slot cover 40 is attached to the clamping arm 12 over outer ends of the guide slots 32, 34. Magnet housing blocking protrusions 42 extend into the guide slot retention lug passages 36 from an inner surface of the cover 40.

The clamping arm 14 includes magnet housings 44, 46 extending laterally therefrom and slidably accommodated, respectively, in the guide slots 32, 34 of the first clamping arm 12. The clamping arm 14 defines a guide slot 50 extending across a width thereof, which slidably receives the magnet housing 24 of the first clamping arm 12.

Magnet housing retention lugs 26 extend upwardly and downwardly from the distal ends 52, 54 of the magnet housings 44, 46. The guide slot 50 defines guide slot retention lug passages 36 extending downwardly and upwardly therefrom. A guide slot cover 56 is attached to the clamping arm 14 over outer ends of the guide slot 46 and includes a magnet housing blocking protrusion 42 extending inwardly therefrom into the passages 36.

Each of the lugs 26 extend upwards or downwards beyond the height of respective guide slot 32, 34, 46, which prevents lateral separation of the clamping arms 12, 14 by retaining the each magnet housing 26, 44, 46 within its respective guide slot 32, 34, 36. The clamping arms 12, 14 are only separable by sliding them to align each lug 26 with a respective one of the passages 36. Because the blocking protrusions 42 extend into the passages 36 with the guide slot covers 40, 56 in place, the covers 40, 56 must be removed prior to separating the arms 12, 14—preventing inadvertent separation during normal opening and closing operations of the clamp assembly 10.

The magnet assembly 16 includes magnets 60, 62, 64, each located in a respective one of the magnet housings 24, 44, 46. The magnets 60, 62, 64 are preferably rare earth magnets, such as neodymium or samarium-cobalt magnets, although electromagnets could be used within the scope of the present invention.

The polarities +/− (see FIGS. 4A, 4B) of the magnets 60, 62 are oriented such that an attractive force therebetween holds the clamping surfaces 20, 22 in the closed position. The polarity +/− of the magnet 64 is preferably oriented relative to that of the magnet 60 such that an attractive force therebetween holds the clamping surfaces 20, 22 in the open position, and more particularly, a fully open position.

This is advantageous in that application of force is required only to transition the clamping surfaces 20, 22 between the open and closed position, and not to maintain the surfaces 20, 22 in either position. Alternately, the polarity (+)/(−) of the magnet 64 is oriented relative to that of the magnet 60 such that a repulsive force therebetween urges the clamping surfaces 20, 22 toward the closed position, reducing the energy required for this transition.

Advantageously, each magnet 60, 62, 64 is situated in its respective magnet housing 24, 44, 46 with a plurality of shims 66. The spacing between the magnets 60, 62 and between the magnets 60, 64 can be adjusted by moving some or all of the shims 66 in a magnet housing 24, 44, 46 to the other side of the magnet 60, 62, 64. The guide slot covers 40, 50 help ensure that the magnets 60, 62, 64 and shims 66 remain in their respective housings 24, 44, 46.

The use of three magnets in each magnet assembly is preferred because it minimizes the number of magnets while still allowing the clamp assembly to be held by magnetic attraction in both the closed and open positions. It will be appreciated that two or more pairs of magnets could be used to the same effect simply by modifying the clamping arms to include a corresponding number of additional magnet housings and guide slots. Likewise, the present invention could be used with only a single pair of magnets, such that magnet attraction only holds the clamp assembly to be held closed (or open).

In operation, the clamping arm 14 is mounted to a carriage via the mounting holes 70, with the clamping arm 12 slidably mounted thereto. An engagement roller 72 extending from the clamping arm 12 is engaged by an external mechanism to transition the magnetic clamp assembly 10 between open and closed positions.

Pouch retention when closed is enhanced by knurled or otherwise textured finishes on opposing faces of the clamping surfaces 20, 22. Since the clamping arms 12, 14 are laterally adjacent, a lateral extension 74 at the distal end 76 of the clamping arm 14 to allow the clamping surface 22 to be located coaxially along a clamping axis opposed to the clamping surface 20. A lateral extension 82 at the distal end 84 of the clamping arm 12 is angled away from the clamping surface 20 and facilitates pouch loading.

The abutting inner sides of the clamping arms 12, 14 preferably completely cover the inner openings of the guide slots 32, 34, 50 while the outer openings of the guide slots 32, 34, 50 are completely covered by the covers 40, 56. This arrangement advantageously inhibits fine particulates commonly encountered during pouching operations from entering the guide slots 32, 34, 50 and interfering with the opening and closing of the clamp assembly 10.

Referring to FIG. 5, according to another embodiment of the present invention, a pair of magnetic pouch clamp assemblies 10A, 10B are each mounted on adjacent carriages 90A, 90B. The clamp assemblies 10A, 10B are mirror-images of one another, such that lateral extensions 74A/B, 82A/B on the distal ends 76A/B, 84A/B of the clamping arms 12A/B, 14A/B extend toward one another, allowing both side of a pouch to accommodated therebetween.

It will be noted that, in the clamp assemblies 10A, 10B, the outboard clamping arms 14A, 14B carry the engagement rollers 72A, 72B while the inboard clamping arms 12A, 12B are mounted to the carriages 90A, 90B. A roller engagement mechanism 92 is positioned to engage the rollers 72A, 72B to simultaneously urge both the clamp assemblies 10A, 10B into the open position.

To help counteract the force exerted on the clamp assemblies 10A, 10B and carriages 90A, 90B, retentions mechanisms 94A, 94B (such as the depicted hooks) are located on proximal ends 96A, 96B of the mounted clamping arms 12A, 12B. These mechanisms 94A, 94B are able to engage a rail or other fixed structure at opening positions for the assemblies 10A, 10B, thereby preventing unwanted movement thereof.

The above-described embodiments are provided for illustrative purposes; the present invention is not necessarily limited thereto. Rather, those skilled in the art will appreciate that various modifications, as well as adaptations to particular circumstances, will fall within the scope of the invention herein shown and described, and of the claims appended hereto.

What is claimed is:

1. A magnetic pouch clamp assembly comprising:
a first clamping arm having a first clamping surface;
a second clamping arm having a second clamping surface opposed to the first clamping surface, the second clamp arm being slidably connected to the first clamping arm such that the first and second clamping arms are movable between open and closed positions, the first and second clamping surfaces being engaged in the closed position;
a magnet assembly including a first magnet having a first polarity carried by the first clamping arm and a second magnet having a second polarity carried by the second clamping arm, the first and second polarities being oriented such that a closing attractive force therebetween holds the first and second clamping surfaces in the closed position.

2. The assembly of claim 1, wherein the magnet assembly includes a third magnet having a third polarity carried by the second clamping arm, the second and third magnets being located on opposite sides of the first magnet and the first and third polarities being oriented such that an opening attractive force therebetween holds the first and second clamping surfaces in the open position.

3. The assembly of claim 1, wherein the first clamping arm defines a first guide slot and the second clamping arm defines a second guide slot, the first clamping arm includes a first magnet housing slidably received in the second guide slot and carrying the first magnet, and the second clamping arm includes a second magnet housing slidably received in the first guide slot and carrying the second magnet.

4. The assembly of claim 3, wherein the magnet assembly further includes at least one first magnet shim located in the first magnet housing with the first magnet, the first magnet shim being repositionable to adjust a spacing between the first and second magnets.

5. The assembly of claim 3, wherein the magnet assembly further includes at least one second magnet shim located in the second magnet housing with the second magnet, the second magnet shim being repositionable to further adjust the spacing between the first and second magnets.

6. The assembly of claim 3, wherein the first magnet housing includes a first magnet housing retention lug at a first magnet housing distal end and the second guide slot includes a second guide slot retention lug passage extending across a width thereof, engagement between the first magnet housing retention lug and the second clamping arm preventing removal of the first magnet housing from the second guide slot except when the first magnet housing retention lug and the and the second guide slot retention lug passage are aligned.

7. The assembly of claim 6, wherein the second clamping arm includes a second clamping arm guide slot cover connected thereto outwardly of the first magnet housing retention lug, the second clamping arm guide slot cover having a magnet housing blocking protrusion extending inwardly therefrom positioned to prevent the first magnet housing retention lug from sliding into aligned with the second guide slot retention lug passage.

8. The assembly of claim 6, wherein the second magnet housing includes a second magnet housing retention lug at a second magnet housing distal end and the first guide slot includes a first guide slot retention lug passage extending across a width thereof, engagement between the second magnet housing retention lug and the first clamping arm preventing removal of the second magnet housing from the first guide slot except when the second magnet housing retention lug and the and the first guide slot retention lug passage are aligned.

9. The assembly of claim 3, wherein the magnet assembly includes a third magnet having a third polarity carried by the second clamping arm, the second and third magnets being located on opposite sides of the first magnet and the first and third polarities being oriented such that an opening attractive force therebetween holds the first and second clamping surfaces in the open position; and
wherein the first clamping arm defines a third guide slot and the second clamping arm includes a third magnet housing slidably received in the third guide slot and carrying the third magnet.

10. The assembly of claim 1, wherein one of the first and second clamping arms includes mounting holes for mounting to a carriage.

11. The assembly of claim 10, wherein another of the first and second clamping arms includes an engagement roller for engagement to move the first and second clamping surfaces between the open and closed positions.

12. The assembly of claim 1, wherein a first clamping arm distal end extends beyond a second clamping arm distal end, the first clamping arm distal end including a first end lateral extension, the first clamping surface being located on the lateral extension facing the second clamping surface on the second clamping arm distal end.

13. The assembly of claim 12, wherein the second clamping arm distal end includes a second end lateral extension extending away from the first clamping arm and angled away from the second clamping surface.

14. The assembly of claim 12, wherein the first and second clamping surfaces are textured to increase grip.

15. The assembly of claim 1, wherein the first and second magnets are permanent magnets.

16. A magnetic pouch clamp assembly comprising:
a first clamping arm having a first clamping surface at a first clamping arm distal end and a first magnet housing extending laterally therefrom, the first clamping arm having a first clamping arm magnet housing extending laterally therefrom;
a second clamping arm having a second clamping surface opposed to the first clamping surface along a clamping axis, the second clamping arm defining a second clamping arm guide slot slidably receiving the first magnet housing; and
a magnet assembly including a first magnet having a first polarity carried by the first clamping arm in the first clamping arm magnet housing and a second magnet having a second polarity carried by the second clamping arm, the first and second polarities being oriented such that a closing attractive force therebetween holds the first and second clamping surfaces in the closed position.

17. The assembly of claim 16, wherein the first clamping arm defines a first clamping arm guide slot and the second clamping arm has a second clamping arm magnet housing extending laterally therefrom and carrying the second magnet, the first clamping arm guide slot slidably receiving the second clamping arm magnet housing.

18. The assembly of claim 16, wherein first and second clamping arm inner sides abut and the second clamping arm guide slot opening in the second clamping arm inner side is completely covered by the first clamping arm.

19. The assembly of claim 18, wherein the first magnet housing includes a first magnet housing retention lug at a first magnet housing distal end and the second guide slot includes a second guide slot retention lug passage extending across a width thereof, engagement between the first magnet housing retention lug and the second clamping arm preventing removal of the first magnet housing from the second guide slot except when the first magnet housing retention lug and the and the second guide slot retention lug passage are aligned.

20. The assembly of claim 19, wherein the second clamping arm includes a second clamping arm guide slot cover connected thereto outwardly of the first magnet housing retention lug, the second clamping arm guide slot cover having a magnet housing blocking protrusion extending inwardly therefrom positioned to prevent the first magnet housing retention lug from sliding into aligned with the second guide slot retention lug passage.
